(19) United States
(12) Patent Application Publication
(10) Pub. No.: US 2006/0051270 A1
(43) Pub. Date: Mar. 9, 2006

(54) Removal of volatile metals from gas by solid sorbent capture

(76) Inventor: Robert Brunette, Seattle, WA (US)

Correspondence Address: JENSEN + PUNTIGAM, P.S., SUITE 1020, 2033 6TH AVE, SEATTLE, WA, 98121, US

(21) Appl. No.: 11/219,015

(22) Filed: Sep. 2, 2005

Related U.S. Application Data
(60) Provisional application No. 60/607,216, filed on Sep. 3, 2004.

(51) Int. Cl. B01D 53/64

(52) U.S. Cl. 423/210

(57) ABSTRACT

A method for removal of mercury from gas, using chemically treated carbons, including the contact of the mercury-containing gas with a chemically treated substrate, wherein the substrate surface has developed metal oxide, carbonyl and halide functionalities.

This application claims the priority of provisional patent application Ser. No. 60/607,216, REMOVAL OF TOTAL MERCURY FROM GAS FLUID MATRIX, filed Sep. 3, 2004 by Robert Brunette.

### TECHNICAL FIELD

This invention relates to a novel application of a material to remove mercury from gas. The gas may be gaseous emissions prior to the discharge of the emissions to the environment or prior to its entry into any cleaning device, or industrial process gases, or gases produced during natural resource recovery, or naturally produced gasses (gases of natural or anthropogenic origin). Mercury present in these gasses is in a volatile form or bound to, a particle. The application involves the addition of a mercury binding agent in the form of a halogenated oxide, impregnated on a solid substrate and placed in contact with the mercury laden gas. This invention can be applied as an emission control device for removing mercury. In application as an emission control device for Hg removal, the gas is either passed through a fixed bed of the material or the material is inserted into the gas via any commercial available carbon injection system, in conjunction with a particulate control device, already in place, or being installed to clean the gaseous emissions prior to the discharge of the emissions to the environment, the industrial process gases, the gases produced during natural resource recovery, or the naturally produced gases (gases of natural or anthropogenic origin). The material is injected upstream or directly into a particulate control system where the subject material comes in contact with the gas, removes gaseous mercury, and in turn is removed by the particulate control device. The resulting formulation described herein, produces a high Hg capacity, high temperature resistant, chemically impregnated dry sorbent.

### BACKGROUND OF THE INVENTION

The present invention is drawn generally to a process for enhancing air quality and restoring the environment through the removal of mercury from gases released to or present in the atmosphere. While this invention will work for additional volatile metals present in a gas, of specific interest is mercury.

It is estimated that 144-189 Megagrams (158-207 tons) of mercury are emitted annually into the atmosphere by anthropogenic sources (where anthropogenic sources are defined as the mobilization or release of geologically bound mercury by human activities, with mass transfer of mercury to the atmosphere), in the United States (Keating, 1997; NADP Mercury Deposition Network). Approximately 87 percent of the mercury is from combustion point sources and 10 percent from manufacturing-point sources. The combustion point sources can be broken down further (Table 1) into four general classes, coal-fired utility boilers, municipal waste combustion, commercial/industrial boilers and medical waste incinerators. All of these are high-temperature waste combustion or fossil fuel processes. In each case the mercury is an impurity in the fuel or feedstock and is volatilized due to the low mercury boiling point and discharged to the atmosphere with the flue gas. Even though mercury is a minor impurity, the large quantity of fuel or feedstock used results in massive mercury discharges.

TABLE 1
Mercury Emissions (in Tons) in the USA Classed
as Point Source Type and Mercury Form of Emission.

| | Elemental | Oxidized | Particulate | Total |
|---|---|---|---|---|
| Sources | Mercury | Mercury | Mercury | Mercury |
| Coal Burning | 38 | 23 | 15 | 76 (45%) |
| Incinerators | 11 | 33 | 11 | 55 (33%) |
| Other Point Sources | 24 | 4 | 2 | 30 (18%) |
| Area Sources | 7 | 0 | 0 | 7 (4%) |
| Total | 80 (48%) | 60 (36%) | 28 (16%) | 168 |

Although research has been devoted to the removal of mercury before it enters an industrial process, efforts such as the clean coal technologies initiative have not produced a viable process for the removal of Hg from coal prior to combustion. Industry has therefore focused their efforts on removing the impurities after the point of combustion or throughout the path of flue gas discharge.

The US EPA, through careful evaluation of several control technologies, has reported that carbon injection of sorbents, ahead of or directly into particulate control systems, is the current state-of-the-art for achieving moderate to high Hg control (EPA Memo 2004). Over the past ten years, carbon injection has been widely tested and commercially proven to remove mercury in application to the municipal solid waste combustor industry. This same technology has been evaluated for mercury emission control from coal-fired utility flue-gas as detailed in a recent publication, “Status Review Of Mercury Control Options For Coal-Fired Power Plants”, Fuel Processing Technology, in press 2002—John Pavish et al). Carbon injection has been the most studied and tested form of Hg removal from gas and appears to be a cost affective approach as most coal-fired utilities have existing particulate control systems and therefore it is expected that a retrofit of an existing system for carbon injection is feasible (EERC MEMO). A typical system injects the sorbent either up stream of or directly on the last cell of the particulate control system. The novel sorbent, once injected into the gas stream, captures Hg from the point of injection (in-flight capture) and continues to capture mercury when collected onto the particulate control device. The material continues to capture mercury until final removal by the particulate control system.

As detailed in Table 1, mercury in coal-fired process gas is identified to be in three general phases: (1) particulate bound mercury (PHg), (2) gaseous elemental Hg (Hg(O)_{g}), and (3) gaseous oxidized mercury (Hg(II)_{g}). Particulate bound mercury, the smallest fraction of total Hg present in coal-fired process gas, is easily removed by existing particulate control systems, which have been refined and updated over the past 25 years. Gaseous oxidized mercury is water soluble and therefore can be removed by wet scrubbers and flue gas desulfurization systems, if these systems are optimized properly, and therefore this fraction of Hg can be removed with existing air pollution control systems. Elemental gaseous mercury is not water soluble and therefore considered to be the most difficult species of mercury to remove from flue gas. Further, it is well understood that elemental gaseous mercury, once emitted to the atmosphere, enters the global Hg cycle and is transported long distances until it undergoes conversion to a form that will fall to terrestrial or aquatic ecosystems. While inorganic mercury itself is not bioaccumulative it is readily converted to a neurotoxin, methyl mercury, in the ambient environment. With the engineering and physical plant technology for carbon injection well refined and studied over the past 5 years, the challenge has been finding a high capacity, high temperature sorbent capable of removing both gaseous oxidized mercury for those plants that don't have a wet scrubber, but more importantly a sorbent capable of removing elemental gaseous mercury.

The US EPA Mercury Study Report to Congress (Keating, 1997) reviewed the mercury removal capabilities of existing air pollution control devices (APCDs). Table 2 summarizes the findings in that section of the report.

TABLE 2
Removal of Mercury by Existing Air
Pollution Control Devices.

| | Hg Removal % | Mean Hg | |
|---|---|---|---|
| Control Device | Range | Removal % | % RSD |
| Flue gas | 0.00-61.67 | 30.85 | 73.16 |
| desulfurization (FGD) | | | |
| Spray Dryer | 0.00-54.50 | 25.59 | 111.53 |
| Adsorption (SDA) | | | |
| Fabric Filter (FF) | 0.00-73.36 | 28.47 | 125.08 |
| Electrostatic | 0.00-82.35 | 23.98 | 107.88 |
| Precipitators - | | | |
| Cold Side (ESP-CS) | | | |
| Electrostatic | 0.00-83.00 | 31.17 | 127.51 |
| Precipitators - | | | |
| Hot Side (ESP-HS) | | | |

What is required to address the concerns of this and other studies, is a technology that can remove all forms of mercury from flue gas, concurrently allowing the captured Hg to be easily separated from the gas stream, in a form that passes all required Toxicity Characteristic Leaching Procedure (TCLP) control limits. Further, it is important to design the application of these dry sorbents, such that the spent dry injection material does not mix in with and therefore negatively impact the cementitious properties of fly ash which is an important revenue generating by-product for the coal-fired industry. Dry injection technology has been adapted to preserve the purity of coal-fired fly ash and has been shown to be adapted to existing plant equipment, thereby reducing equipment and implementation costs.

Although there are several commercially available dry sorbent materials, most experience significant failures with one or more of the following aspects of Hg removal from gas: (1) limited operational range of temperature (2) limited mercury capacity (3) poor capture efficiency and (4) expense related to the need for additional capital equipment. The subject invention has been specifically designed to successfully overcome these difficulties as demonstrated below.

Chemically impregnated carbons have been the focus of much research for the removal of mercury from gaseous emissions, but many have been found to be inefficient. A full review of powder activated carbon injection as applied to coal-fired utilities has been recently reported (Pavish et al). Disadvantages of carbon injection noted are the large mass of carbons required to adsorb mercury (limited mercury capacity of sorbent) and low mercury capture efficiency at temperatures above 130 C. Commercially available carbons such as Sorbalite™ have been reported to only have a 55-65% capture efficiency for mercury and it is further reported that more common carbon injection products such as sulfur and iodine impregnated carbons have been found to remove mercury efficiently only at temperatures below 75 C in dry gasses (Shoubary et al). Coal fired-flue gas is typically 200-500 F at the particulate control system and found to have 5-12% moisture, making these commercially available carbons unviable.

U.S. Patent 2004/0074391 A1 describes an improved filtration system where a filter element is combined with the use of a chemically impregnated carbon (Durante et al.). Durante describes the use of “preferred binding agents” and “preferred promoters” from a family of each of these materials that produces a high temperature, high capacity Hg removal sorbent. The patent describes the preferred combination of binding agent and promoters to be potassium iodide and zinc acetate tested at temperatures up to 185° C. and reporting Hg capture capacity as high as 3% by weight. In contrast, the subject material utilizes a completely different family of chemical constituents (metal oxides, halides, and halide salts accompanied by carbonyl groups) and has been tested to have a 99% Hg removal efficiency at a wide range of gas temperatures (99% removal at temperature from 200° F. to 1000° F.).

U.S. Pat. No. 6,589,318 describes mercury removal using a powder activated carbon impregnated with calcium hydroxide, cupric chloride and potassium iodide (El-Shoubary, et al). This patent demonstrates the removal of mercury emissions specifically from thermally treated Hg contaminated soils in a kiln treatment process, involving high temperature operation and high moisture environment. The process claim states an operation temperature of 360° F.

Regenerable sorbents have been examined such as that detailed in U.S. Pat. No. 5,409,522 (Durham et al) where the use of a regenerable Hg sorbent consisting of a substrate that is coated with a noble metal which, after use, is thermally regenerated and re-used. Although these systems are novel from the standpoint of re-use of the sorbent, the application requires specialized equipment and further, during the regeneration process, the captured mercury is then passed onto another, inexpensive sorbent, like activated carbon, requiring a significant additional step. Further, this secondary sorbent is required to then be land filled and therefore regenerable sorbents have removed this significant waste stream. Amalgamation of Hg on noble metals is also well known to have significant difficulties with acid gases, organics and other chemical constituents present in flue gas, that degrade the sorption surface. Further, it is also understood that noble metal surfaces are eventually degraded by continued exposure to high temperatures that also eventually degrades the sorption surface. All of these factors limit the number of regeneration cycles of this material; therefore the economy of regenerable sorbent systems is relatively unknown.

### SUMMARY OF THE INVENTION

The disclosed invention relates to a novel application of a material to remove mercury from a gas. The gas may be gaseous emissions prior to the discharge of the emissions to the environment, or industrial process gases, or gases produced during natural resource recovery, or naturally produced gases (gases of natural or anthropogenic origin). The mercury of concern is in a volatile gaseous form. The volatile gaseous mercury may also bind to a particle in the gas stream. The application involves the addition of a family of halides in the presence of carboxylate salts including by not limited to Mg(II), ca(II), Cu(II) and Zn(II), impregnated onto a family of substrates including, but not limited to carbon (including but not limited to charcoal, powder activated carbon, coal coke), silica, ash, fly ash, rhyolitic ash, rhyolitic tuff, or other natural or synthetic substrates that meet the specifications of this application. This invention is then introduced into the mercury laden gas stream in a form including, but not limited to, a fixed bed or carbon injection/particulate control system that is in place, or being installed to clean the gaseous emissions prior to the discharge of the emissions to the environment, the industrial process gases, the gases produced during natural resource recovery, or the naturally produced gases.

### BRIEF DESCRIPTION OF THE DRAWINGS

FIG. 1. Experiment schematic for pilot testing of a halide, impregnated on a carbon substrate, for addition to a mercury laden gas for removal of all species of gaseous mercury, in a simulated dry injection application.

FIG. 2. A plurality of tables documenting the removal of elemental mercury from a gas phase by the addition of the subject invention in a simulated dry injection application.

FIG. 3: The removal efficiency results of 10-40 mg Hg/mˆ3 elemental mercury from gas, due to the addition of the subject invention, in a simulated dry injection application.

FIG. 4: The results of gaseous elemental removal test-capture efficiency test.

FIG. 5: The removal of 100 ug Hg/mˆ3 elemental mercury from gas, due to the addition of the subject invention at a temperature of 500 F.

FIG. 6: The removal of 100 ug Hg/mˆ3 elemental mercury from gas, due to the addition of the subject invention at a temperature of 975 F.

FIG. 7: Upper temperature limit of subject invention during a test where 100 ug Hg/mˆ3 elemental mercury was introduced at a temperature greater than 1200 F.

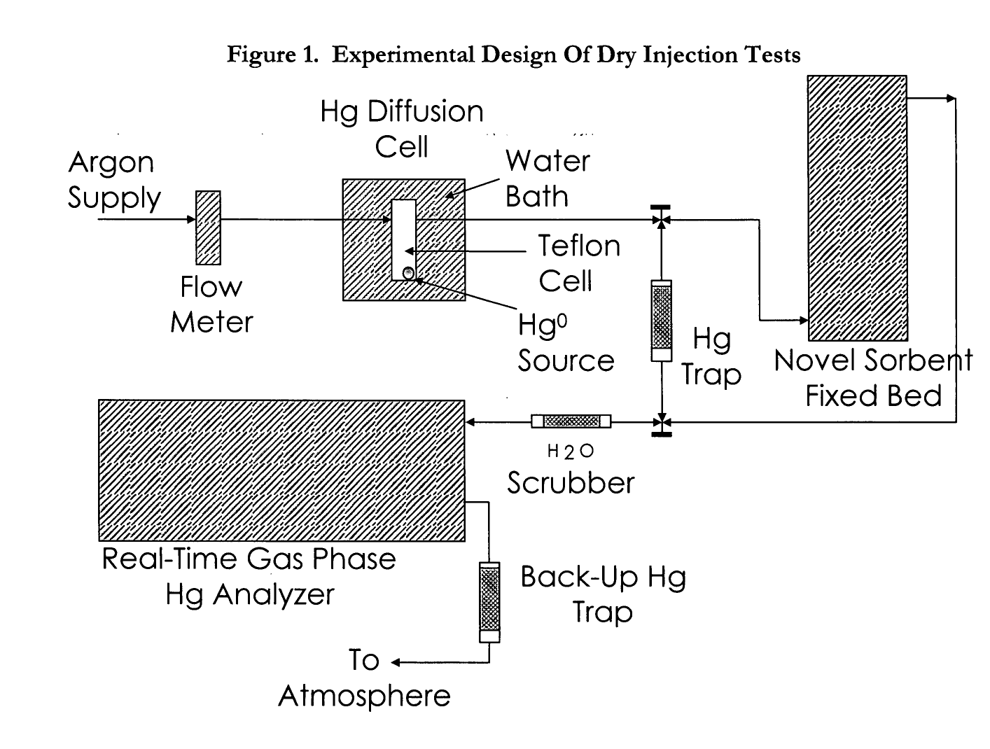

### BEST MODE FOR CARRYING OUT THE INVENTION

The present invention is directed to a new and improved method for removing mercury from gas. The method consists of adding a halogenated oxide compound to a solid substrate, where the substrate in turn is injected into and put in contact with a gas via a fixed bed or more commonly via carbon injection system and then captured on an existing particulate control system. Not bound by theory, it is believed that the halogenated oxide impregnated substrate adsorbs and absorbs both oxidized and elemental mercury from the gas phase onto the subject material, where the subject material is then in turn removed from the gas phase by an existing, retrofit/modified or new particulate control system including but not limited to a baghouse, cold-side electrostatic precipitator, hot-side electrostatic precipitator, or other such particulate control system, existing or not.

The postulated mechanism for the capture of both elemental and oxidized gaseous mercury by the invention is via a combination of chemisorption and physisorption where chemical and physical bonds are formed between the gas phase Hg and the surface and subsurface of the subject material, in some cases, aided by the formation of carbonyl groups (C═O) present from the impregnation of the halide and metal oxide. The bound mercury on the invention then follows the fate of a particle in the gas stream where it is removed via the particulate control system.

The presented invention involves the removal of mercury. Of course this is just one example, and the method is expected to find commercial application to all volatile toxic heavy metals found in a gas phase fluid. Where “heavy metals,” are individual metals, semi-metallic metals, other metals and metal compounds that negatively affect the health of people. At trace levels, many of these elements are necessary to support life. However, at elevated levels they become toxic, may build up in biological systems, and become a significant health hazard. Although not limited to, as of 14 Apr. 1999 the U.S. Department of Labor, Occupational Safety & Health Administration defined toxic metals as: Aluminum, Antimony, Arsenic, Barium, Beryllium, Bismuth, Boron, Cadmium, Calcium, Chromium, Cobalt, Copper, Hafnium, Iron, Lead, Magnesium, Manganese, Mercury, Molybdenum, Nickel, Osmium, Platinum, Rhodium, Selenium, Silver, Tantalum, Tellurium, Thallium, Tin, Titanium, Uranium, Vanadium, Yttrium, Zinc, Zirconium. The form of these toxic metals in the gas are defined as the species of toxic metals present, where the toxic metals may be present in the gas phase, or bound to, a particulate. The toxic metals may also be present in elemental or ionic form, or associated to, or bound in, a gaseous volatile compound.

Gas is considered any anthropogenic or natural gas. The mercury binding agent is a halide, from the group consisting of but not limited to the family of Halogens, but preferably those derived from Iodine and Bromine salts and MgO that are in turn impregnated onto a family of substrates, including but not limited to carbons (including by not limited to charcoal, powder activated carbon, coal coke etc), silica, ash, fly ash, rhyolitic ash, rhyolitic tuff, or other natural or synthetic substrate that meets the specifications of this application.

In its broadest form, the present invention comprises a method for removing mercury from the gas generated during the combustion of fossil fuels or solid wastes through the use of a halogenated oxides impregnated on the surface of a substrate, able to complex and trap oxidized or elemental gaseous mercury. Of course, while the aforementioned coal-fired utility boiler installations are but one example, and the method of the present invention will likely find commercial application to the removal of mercury from gas produced by such utility boiler installations which combust such fossil fuels, where any industrial process using a fixed or a particulate control system modified to accept and capture injected materials, or other such device, that includes this invention, designed to purify gas phase fluids, may benefit. Such processes could include incineration plants, waste to energy plants, or other industrial processes which process or carry gases containing mercury, including pipelines that carry fuel gasses such as natural gas and the like.

It is expected that no additional materials will be required to satisfy this invention. However, in certain cases the halogenated oxide may require impregnation onto any one of several suitable substrates, to aid in either the application or to suite a specific gaseous matrix, in order to facilitate the transfer of the species of mercury from the gas to the invention material. The substrate could be any one of the following, but not limited to the family of carbons (including powder activated carbon, charcoal and coal coke), silica, ash, fly ash, rhyolitic ash and or rhyolitic tuff or any other natural or synthetic substrate that meets the specification of this or ay other such system.

In one embodiment, an aqueous solution containing the appropriate halide and oxide combination (solution A), including but not limited to a ratio of 2:1:250 (halide, oxide and water) is mixed until all reagents are completely dissolved. Solution A is then added to a suitable substrate (previously described). The material and solution A are then thoroughly mixed to ensure sufficient coating of Solution A onto the substrate. The substrate is then dried to remove waters of hydration and ready for use. With an appropriate porous substrate, as exhibited with some carbons, the impregnation of the material invention, after careful analysis, exhibits the chemical impregnation of both the outer and inner matrix surfaces of the substrate. This material invention can therefore demonstrate both adsorption and absorption of mercury (external and internal capture of Hg on the substrate) facilitating the high capture efficiency and capacity for mercury.

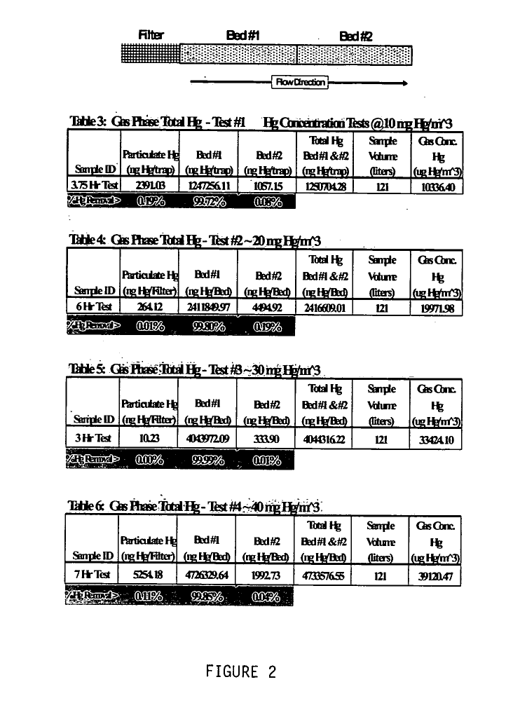

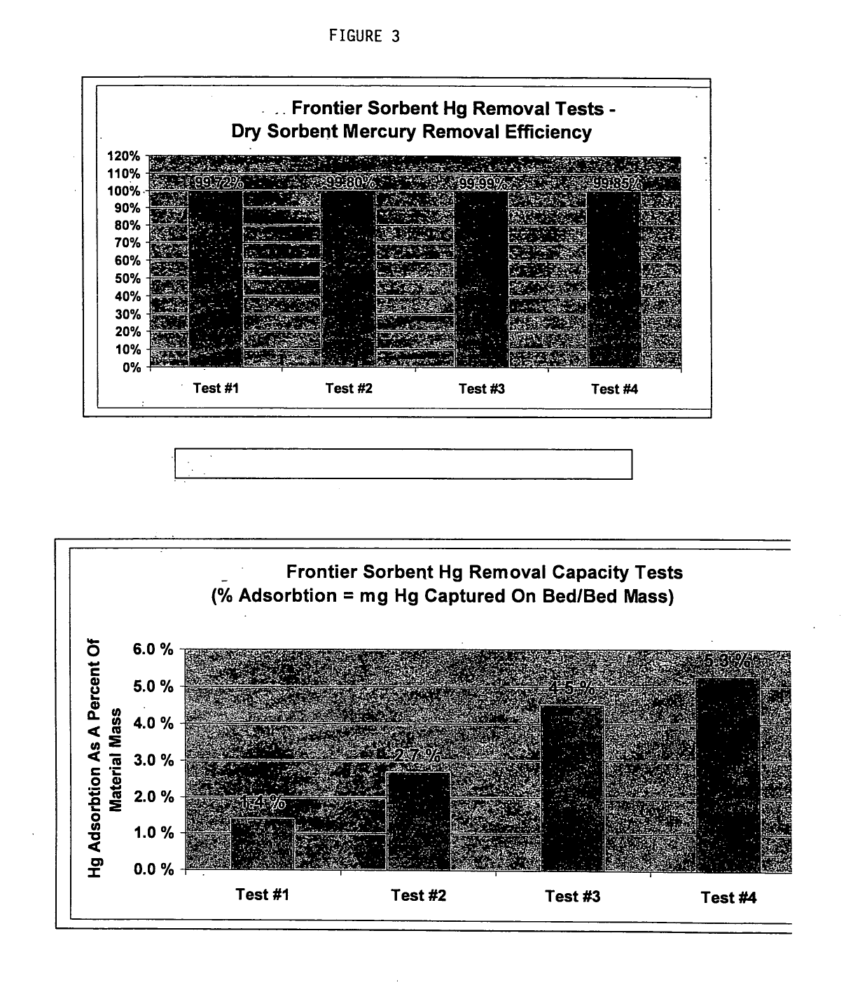

In one example, but not limited to, FIG. 3 demonstrates the subject invention and its' Hg Removal Capacity. Two specified amounts of the subject invention material were packed into columns and separated by an inert porous bed support. This effectively created a testing column with 2, in series tandem “beds”, bed “A” and bed “B” (see FIG. 2). The bed diameter and length were designed to simulate the application of the novel sorbent either in a fixed bed or dry injection application onto a baghouse (or other particulate control device). The design of the test bed factored flow rates expected to be seen in full scale applications.

The tests on the subject invention, described in Drawing 1, utilize a Teflon cell containing a calibrated Hg diffusion cell. The Teflon cell is placed in a water bath at 50 C. This results in an emitted gas stream containing gaseous Hg⁰, capable of producing concentrations many times that of what is typically measured and observed in coal-fired flue gas and therefore considered worst case scenario. The gas stream can be directed through a Hg sample trap, a real-time Hg analyzer instrument, or through the pilot dry sorbent. Prior to entering the real-time Hg instrument (a portable Hg vapor analyzer) the gas passes through a H₂O scrubber, in order to eliminate any water vapor present from quenching the fluorescence signal. The real-time Hg analyzer is being used in an external cell configuration, and so another Hg trap is placed on the vent to atmosphere.

In another example, but not limited to, a series of 4 tests were performed to asses and demonstrate the Hg removal capacity of the invention material. Each of the four tests performed involved running a known volume of gaseous elemental mercury with Hg concentrations ranging from 10 to 40 mg Hg/mˆ3, through the test bed, for a specified period of time. The lowest test concentration (10 mg Hg/mˆ3) used in these tests is approximately 1000 times higher than that actual high-end range of Hg found coal fired flue gas (0.010 mg Hg/mˆ3). These concentrations were specifically designed to create worst case scenario conditions. After the exposure time, each of the two test beds were individually harvested, digested and analyzed for Hg content enabling the assessment of breakthrough and capture efficiency of the material under these rigorous testing conditions.

Tables 3-6 (FIG. 2) record the results of Hg removal from each test. The four tests demonstrate that the invention material was able to efficiently remove Hg concentrations from 10-40 mg Hg/mˆ3. The results from these tests demonstrate that the first bed of each test column removed 99.7%, 99.8%, 99.9 and 99.9% respectively of the Hg introduced to the subject material, demonstrating that each increasing Hg concentration had no affect on the Hg removal capability of the material. Overall, the tests show that the mercury removal efficiency for this material under these test conditions is 99% or greater.

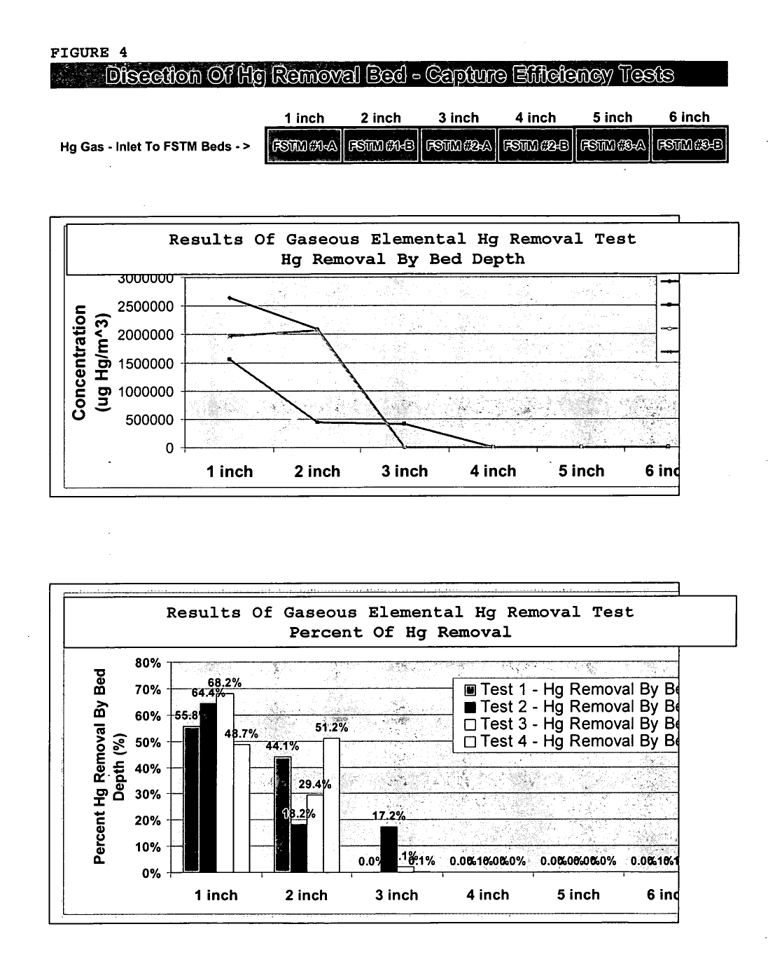

In another example but not limited to, FIG. 4 illustrates that each test bed was measured horizontally in inches, dissected in 1 inch sections and measured for mercury content to understand Hg breakthrough and Bed Hg adsorption/absorption capacity. FIG. 4 demonstrates that 99% of the % Hg captured was located on the first two inches of each of the four test beds indicating that these concentrations came no where near the sorbtion capacity of the material. Based on these tests, the material was able to capture Hg in a range from 1.4 to 5.3% of its mass in Hg (FIG. 6) at a 99% Hg removal efficiency. The aforementioned tests, from a Hg capture per gram basis, report 8.3-32.0 mg Hg/gram of the subject invention. Further, it should be noted that the results from these tests indicate that the subject material did not reach its maximum Hg removal capacity. Future tests will be conducted to assess the maximum Hg holding capacity of the material.

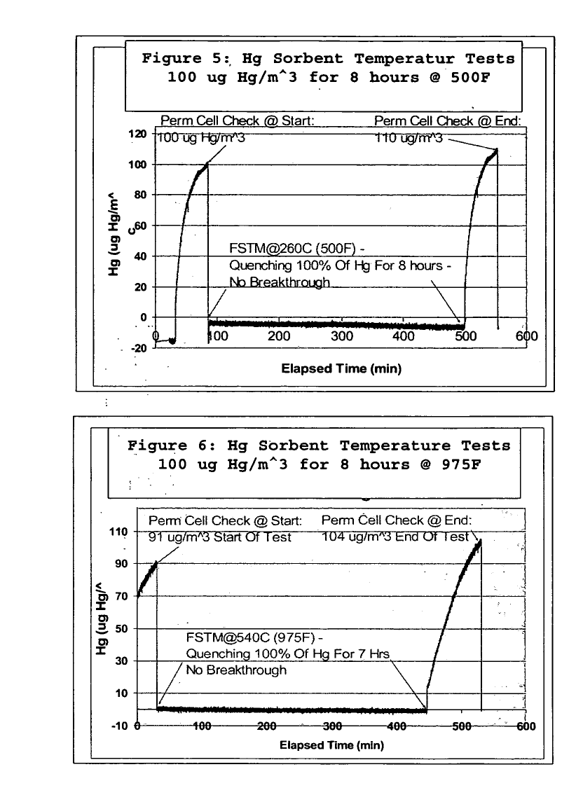

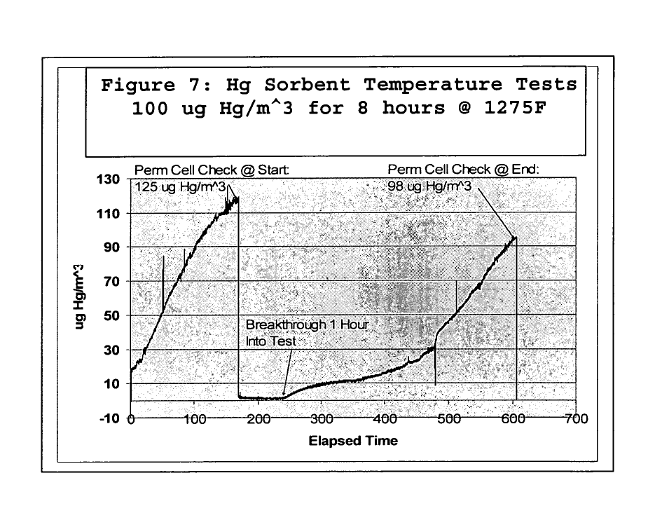

In another example, but not limited to, FIGS. 5-7 demonstrate the affect of temperature on the subject material. As noted previously, temperature can have a major affect on Hg removal efficiency and Hg removal capacity of solid sorbent materials. The experiments were conducted by utilizing the same test design as described in drawing 1 with the addition of a heating block that surrounded the fixed bed of subject material, enabling control of the temperature that the material experienced while running gaseous elemental mercury through the test bed. 100 ug Hg/mˆ3 concentrations (10 times that of the high end range of mercury concentrations found in coal-fired flue gas) were run through the test bed at three operating temperatures ranging from 500 F to 1200 F.

FIGS. 5-7 demonstrate that the effectiveness of the subject material at 500 F and 975° F. respectively. These tests demonstrate that the subject material can capture mercury beyond 975° F. with no breakthrough (99% removal of gaseous Hg(O) at 975° F. or greater) and further demonstrates that a fixed bed or carbon injection system can be applied anywhere downstream from the point of combustion at temperatures ranging from ambient to as high as 975° F. but less than 1275° F. FIG. 6 demonstrates that the novel sorbent material does not fail until the bed reaches 1275° F. This temperature is far in excess of the typical temperature that a carbon injection or fixed bed material would ever experience and is equivalent to the temperature of the actual burner of a coal-fired utility, once again, showing the rigor of this material at high temperature.

In all embodiments the halide and oxide impregnated substrate would be added to and put in contact with the Hg laden gas. As the subject invention only needs to be put in sufficient contact with the gas stream, the system design or implementation there of, can be applied to any configuration of equipment that constitutes the concept of a dry injection system design or fixed bed or other such application. The method according to the present invention can be easily adapted to an existing, or to-be-constructed, installation using a fixed bed or dry injection system. The subject invention could be delivered to the gas via an injection delivery system, including but not limited to a designated hopper designed to feed the material into the gas stream. A person skilled in this art can determine the most effective and economical amount of subject material to inject and the most effective means of delivery. In any application, the critical feature is to ensure supplying the halide impregnated material to scrub the gas, in an amount sufficient to reduce the concentration of mercury in the gas to the desired level.

### REFERENCES

Keating, M. H. (1997) “An Inventory of Anthropogenic Mercury Emissions in the United States”, US EPA Mercury Study Report to Congress Volume II: Report# EPA-452/R-97-004”
NADP Mercury Deposition Network, http://nadp.sws.uiuc.edu/mdn/
Air Pollution Prevention and Control Division—National Risk Management Research Laboratory-Office Of Research and Development, “Control Of Mercury Emissions From Coal-Fired Electric Utility Boilers” US EPA 2004 Memo
“Activated Carbon Injection For Mercury Control In Coal-Fired Boilers). Energy & Environment Research Center—Center For Air Toxic Metals—Newsletter, May 2000 (volume 6, Issue 1)
Pavish, J. (2002) “Status Review Of Mercury Control Options For Coal-Fired Power Plants”, Fuel Processing Technology.
El-Shoubary, et al. [U.S. Pat. No. 6,589,18] (2003) “Adsorption powder for removing mercury from high temperature, high moisture gas streams”.

1. A method for the removal of mercury form gas using chemically treated carbons; comprising the steps of contacting a chemically treated substrate with a mercury containing gas wherein the chemical treatment of the substrate develops metal oxide, carbonyl and halide functionalities on the surface, and in some cases, subsurface of selected substrates.

2. The method in accordance with claim 1, wherein the metal oxides are from the group including, but not limited to, copper oxide, magnesium oxide, zinc oxide.

3. The method in accordance with claim 1, wherein the halide functionalities are from the group including, but not limited to, fluorine, chlorine, iodine, bromine, iodates, and bromides.

4. The method in accordance with claim 1, wherein the material is impregnated onto a substrate including, but not limited to, the family of carbons (including, powder activated carbon, charcoal, coal coke), silica, ash, fly ash, rhyolitic ash and or rhyolitic tuff.

5. The method in accordance with claim 1, wherein the gas is passed through a fixed bed modified with the invention material.

6. The method in accordance with claim 1, wherein the material is added into the gas.

7. The method in accordance with claim 1, wherein the material is captured by a particulate control device.

8. The method in accordance to claim 1, where in the subject invention can withstand a wide range of temperatures (ambient to greater than 1000° F., but less than 1275° F.) and maintain a high Hg removal efficiency.

9. The method in accordance to claim 1, where in the subject invention can remove a wide range of Hg concentrations and a high Hg capacity up to and likely greater 5% of the materials mass in mercury.
